(19) United States
(12) Patent Application Publication
(10) Pub. No.: US 2009/0174212 A1
(43) Pub. Date: Jul. 9, 2009

(54) BARBEQUE GRILL INTEGRATED TO PICK-UP TRUCK TAILGATE

(76) Inventors: John A. Donoho, Myakka City, FL (US); Michael L. Donoho, Myakka City, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/233,193

(22) Filed: Sep. 18, 2008

Related U.S. Application Data
(60) Provisional application No. 60/994,258, filed on Sep. 18, 2007.

(51) Int. Cl. B62D 25/08

(52) U.S. Cl. 296/56

(57) ABSTRACT

A system is presented for integrating a cooking device, such as a barbeque, into the tailgate portion of a pick-up truck or other automobile. When the tailgate is folded down to the open position, covers can be opened which expose the contained cooking device. When in the stowed position, the device approximates the appearance of the original vehicle tailgate. The system includes a battery pack for electrically powering the cooking device and/or receiving power from the vehicle electrical system or other external supply. A curved removable drip pan which is shaped to maximize usable volume is provided for catching and discarding grease from the device. The system may be supplied as a retrofit within an existing vehicle tailgate or as a direct replacement for the original factory-supplied tailgate.

### CROSS-REFERENCE TO RELATED APPLICATIONS

The present application claims the benefit of U.S. Provisional Patent Application Ser. No. 60/994,258, filed Sep. 18, 2007, entitled “Barbeque Grill Integrated to Pick-Up Truck Tailgate,” which is herein incorporated by reference in its entirety.

### TECHNICAL FIELD OF THE INVENTION

The present invention generally relates to portable outdoor cooking devices and, more particularly, to an outdoor cooking device integrated into the tailgate of a vehicle.

### BACKGROUND OF THE INVENTION

Many of those attending an outdoor sporting event, concert, or other gathering enjoy arriving early to socialize. Such situations often involve barbecue grills, as “tailgating” is a favorite hobby. Some consumers bring along large, cumbersome grills that are time-consuming to set up and take down. Such grills are also often bulky and difficult to store and transport in a vehicle. Because of this, many consumers find it difficult to transport a grill at all due to other items being carried to and from the event. In addition, grills designed for home use may be dangerous to transport, particularly if powered by propane gas. When vacationing, taking a road trip, or spending time at a campground, most families find grilling out to be quite enjoyable. However, without space to store and transport a personal grill while on the road, this method of cooking is not considered feasible.

### SUMMARY OF THE INVENTION

Accordingly, in one aspect, an outdoor cooking device is disclosed comprising: a body portion; a cooking unit contained in said body portion; a cooking unit cover which conceals said cooking unit when said cooking unit cover is in the closed position; and a storage compartment which is contained in said body portion and separate from said cooking unit; wherein said device is hingedly to a vehicle configured to match the size and shape of a standard tailgate for the vehicle such that said the device may be installed as a direct-fit replacement for said standard tailgate; wherein said cooking unit cover is hingedly attached to and recessed within said body portion such that the outer surface of said cooking unit cover lies flush with the outer surface of said body portion when said cooking unit cover is in the closed position.

### BRIEF DESCRIPTION OF THE DRAWINGS

FIG. 1. is a schematic perspective view of an integrated tailgate and cooking device installed in a pick-up truck according to one embodiment of the present invention.

FIG. 2 is a schematic perspective view of the device of FIG. 1 shown with the tailgate open and the device in the stowed position.

FIG. 3 is schematic perspective view of the device of FIG. 1 shown with the tailgate closed and the device in the stowed position.

FIG. 4 is an enlarged schematic perspective view of the device of FIG. 1.

FIG. 5 is an exploded view of the device of FIG. 1.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

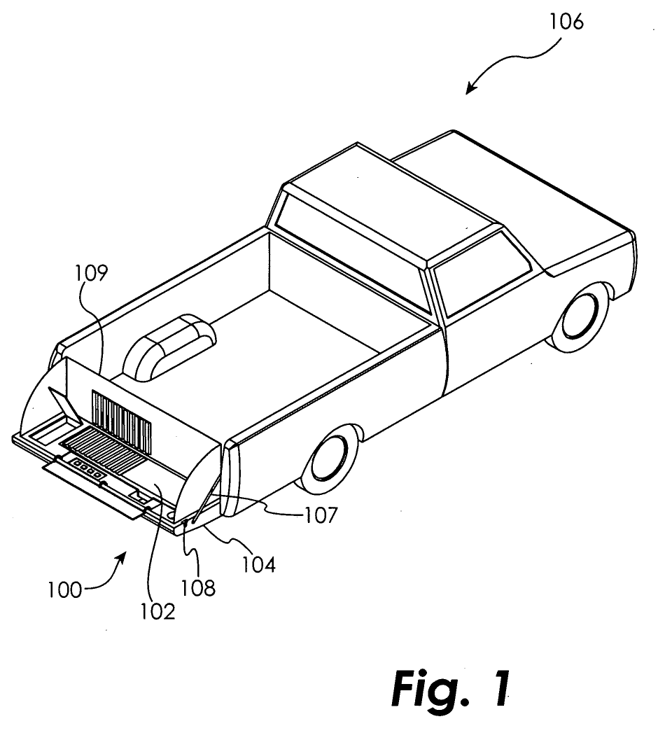

FIG. 1 presents a device 100 comprising a cooking unit 102 which is integrated into the tailgate body 104 of a vehicle 106, such as a pick-up truck, sport utility vehicle or other multi-passenger automobile. The device 100 can be configured to conform to the standard tailgate of virtually any make or model of vehicle. The outer dimensions of the device 100 are configured to closely approximate those of the vehicle's original factory-supplied tailgate which is hingedly connected to the body of the vehicle 106. As with a standard truck tailgate, the device 100 is held in the horizontal/open position by retaining straps 107 and held in the vertical/closed position by latches 108 (located on opposite ends of the device 100) which engage corresponding latching mechanisms on the body of the vehicle 106. The device 100 may be configured as a factory-installed replacement for the standard tailgate or provided as a retrofit unit for after-market installation.

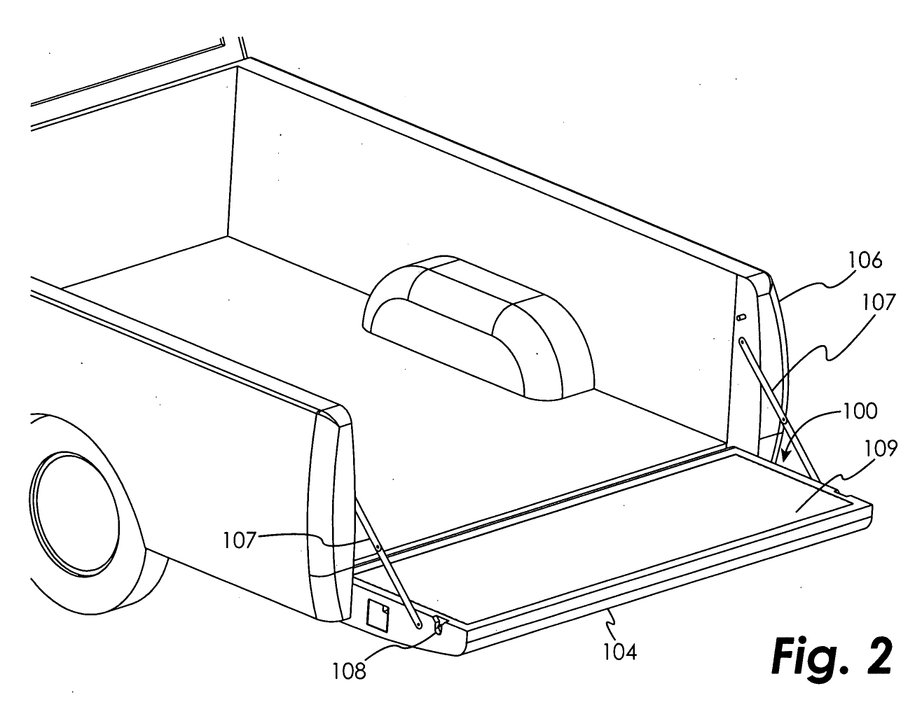

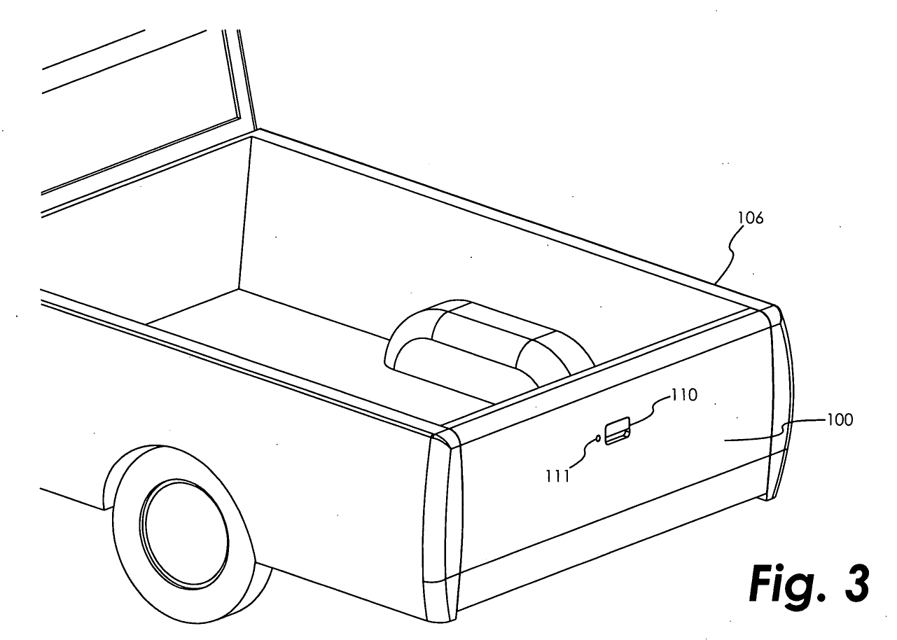

The device 100 further comprises a cover 109 which may be opened to reveal the cooking unit 102. When the cooking unit 102 is not in use, the cover 109 may be closed, concealing the cooking unit 102 from view and allowing the device 100 to function as a normal tailgate for the vehicle 106. FIG. 2 shows the device 100 in the lowered (open) position with the cover 109 closed. FIG. 3 shows the device 100 in the raised (closed) position, with the cooking unit 102 stowed and ready for travel. As illustrated in FIGS. 2 and 3, with the device 100 in the stowed stated, the device 100 substantially matches the dimensions of the original tailgate, thereby maintaining full use of the cargo area of the vehicle 106 when traveling to and from destinations.

In a preferred embodiment, a handle 110 is provided which, when pulled by the user, disengages the latches 108 and allows the device 100 to be moved to the open or horizontal position in the same way the original factory tailgate operates. In certain embodiments, the handle 110 is augmented by a lock cylinder 111 which prevents the device 100 from being placed into the open position without the use of a key. The lock cylinder 111 may optionally be integrated into the vehicle's remote and/or electric central locking functionality. The exterior surfaces of the device 100 may also be painted to match the color and finish of the adjacent surfaces of the vehicle 106.

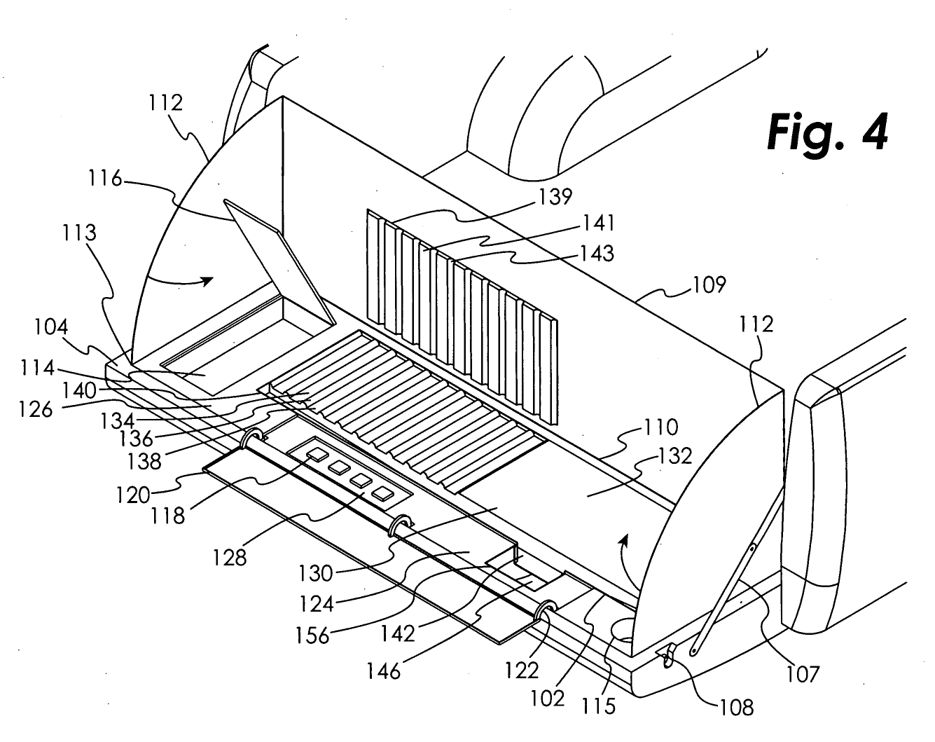

As further illustrated in FIG. 4, the cover 109 is hingedly attached to the tailgate body 104 by a hinge 110. It shall be understood that the hinge 110 may comprise a continuous hinge or individually spaced connection points along the length of the cover 109. When moved to the closed position, the cover 109 may be held in place by a keyed lock or other fixing means known in the art such as a keyed locking cylinder, a bracket for use with a pad lock, or a simple non-keyed latching mechanism. For example, the cover 109 may be fitted with a lock cylinder keyed to the same key as the passenger doors of the truck 106 to prevent the need for the user to carry a separate key for the device 100.

Side supports 112 are provided on the ends of the device 100 which, when opened, fit into slots 113 and may be also fastened to the cover 109, thereby reciprocally holding the cover 109 in the upright position. The cover 109 and the side supports 112 thereby form a protective barrier between the cooking unit 102 and the exterior surroundings. This prevents outside contaminants from reaching food being prepared on the cooking unit 102 and prevents nearby patrons or guests from accidentally touching the hot cooking unit 102. The cover 109 and side supports 112 also help to contain any splattering grease which may damage the other painted surfaces of the vehicle 106. Although the side supports 112 have been illustrated as a quarter-circle in shape, it shall be understood that the side supports 112 may be implemented in various other shapes including, but not limited to, triangles and rectangles.

The side supports 112 are configured to fold onto the cooking unit 102 when not in use. In one embodiment, the side supports may be hingedly connected to the cover 109, whereby the side supports 112 will first fold horizontally to mate with the cover 109 and then fold down vertically and be concealed under the cover 109. In another embodiment, the side supports may be hingedly connected to the tailgate body portion of the device 100, whereby the side supports 112 will first be folded down vertically to rest on the cooking unit 102, with the cover 109 then folded down vertically on top of the side supports 112 and the cooking unit 102.

The device 100 further comprises a storage compartment 114 for storing various cooking utensils, napkins, plates, or other items needed for preparing food. The storage compartment 114 is preferably recessed into the tailgate body 104 and is enclosed by a movable lid 116 which is hingedly connected to one side of the storage compartment 114. In certain embodiments, the storage compartment 114 can be configured as an insulated or refrigerated food storage unit, depending on the needs of the user. For operator convenience, a cup holder 115 is configured as a recess formed into the tailgate body 104.

Controls 118 are provided within the device 100 for controlling the various functions of the cooking unit 102. Such functionality includes, but is not limited to, temperature control, on/off and heating element selection. Control lid 120 is provided to cover the controls 118 and is connected to the device 100 by hinges 122. The hinges 122 are preferably configured as a semicircle or other shape such that the hinges 122 are completely concealed when the control lid 120 is closed. The surface 124 near the controls 118 is preferably recessed into the surface 126 of the device 100 such that when the control lid 120 is closed, the control lid 120 will mate with the surface 124 and remain flush with the surface 126. The control lid 120 may be closed to prevent the controls 118 from being unintentionally adjusted when the operator steps away from the device 100 (or even unintentionally activated by the operator if the operator is using the cooking unit 102 as a temporary shelf or preparation surface before the cooking unit 102 is turned on). The surface 128 immediately surrounding the controls 118 is preferably recessed into the surface 124 such that the control lid 120 does not touch the controls 118 when the control lid 120 is in the closed position.

The cooking unit 102 comprises a heated cooking surface 130 for heating/grilling food. The cooking surface 130 may comprise a flat portion 132 for use as a griddle or hot plate, and a first ridged portion 134 for grilling certain meats. The raised ridges 136 of the first ridged portion 134 elevate the cooking meat from the interim surfaces 138, thereby minimizing any sticking of food to the cooking surface 130 and providing a more “grilled” effect (e.g., char lines on meat). The cooking surface 130 is preferably coated with a non-stick material such as Teflon® to provide ease of cleanup after use. In certain embodiments, the cooking surface 130 may be sloped in order to promote excess grease drainage away from the cooking surface 130.

In still further embodiments, the cover 109 comprises a second ridged portion 139 which is has protrusions 141 and indentations 143 formed therein. The protrusions 141 and indentations 143 are formed to mate with the interim surfaces 138 and raised ridges 136 respectively. The second ridged portion helps to provide stiffness and strength to the cover 109, helps to prevent relative lateral movement of the cover 109 in relation to the device 100 while maximizing compactness of the device 100.

The cooking surface 130 is configured within and surrounded by a recessed grease collection surface 140 such that any grease or liquid food residue which runs over the edge of the cooking surface 130 will fall into the grease collection surface 140. The grease collection surface 140 is preferably sloped from the left and right sides of the cooking surface 130 and down towards an opening 142 of the grease collection surface 140. The bottom apex of the grease collection surface 140, in addition to sloping downward from the left and right edges, is also formed to slope downward toward the operator side of the cooking surface 130. Draining grease is therefore directed by gravity toward the bottom apex of the grease collection surface 140 and toward the opening 142. The grease passes through the opening 142 and into a grease container 146.

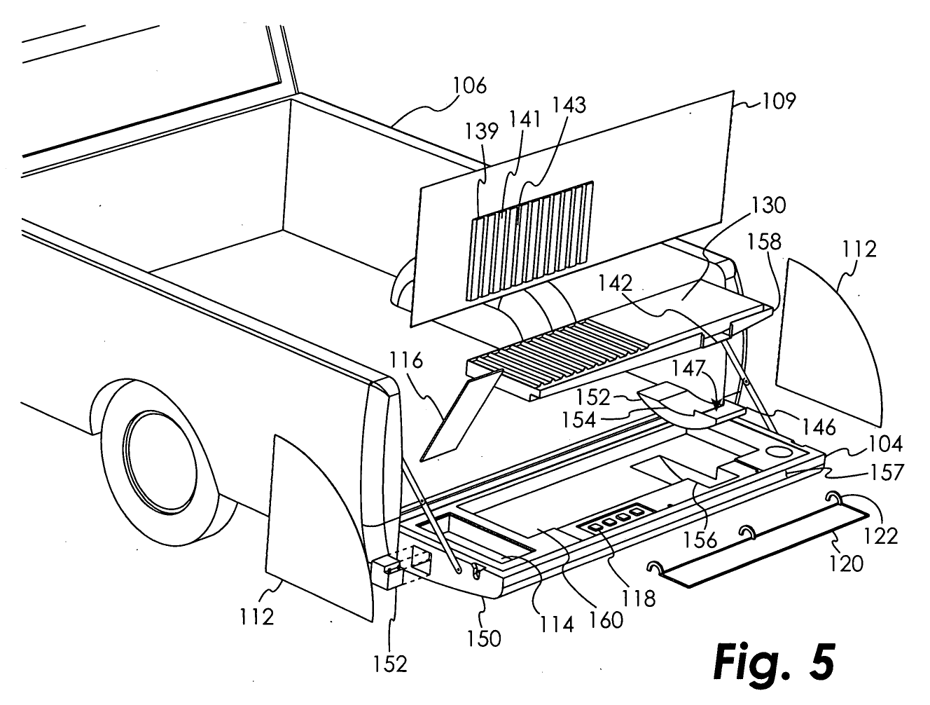

As illustrated in the exploded view of FIG. 5, the grease container 146 comprises a generally curved shape which fits into a corresponding curved recess 148 within the tailgate body 104. The grease container 146 has an opening 147 for receiving grease from the opening 142 of the grease collection surface 140. In certain embodiments, the curvature of the bottom surface 150 of the tailgate body 104 also lends to increased possible depth of the grease container 146. Due to the curvature of the surfaces 152 and 154, the grease container 146 may be removed through the opening 156 in a circumferential or rotational direction which follows the curvature of the grease container 146. The unique curvature of the grease container 146 and placement of the opening 147 also enable the user to remove the grease container 146 through the relatively small horizontal opening 156 without spilling any of the liquid contained in the grease container 146. After the collected grease is externally discarded, the grease container 146 is then placed back in position through the opening 156 in a reverse manner. In addition, the unique shape of the grease container 146 and placement of the opening 147 ensure that the grease will be confined within the grease container 146, even when the device 100 is in the closed/raised position. This eliminates the need for the user to empty the grease container 146 before stowing the device 100 for transport.

The ability of the grease container 146 to be removed through the horizontal opening 156 allows the cover 109 to conceal the grease container 146 and allows the vertical surface 157 of the tailgate body 104 to be continuous and uninterrupted. This adds to the visual appearance, integrity and load bearing strength of the tailgate body 104.

In certain embodiments, the grease collection surface 140 may be implemented as a removable unit 158 as shown in FIG. 5 to facilitate occasional cleaning. In other embodiments, the grease collection surface 140 may be simply be implemented as a recess 160 in the tailgate body 104, also shown in FIG. 5.

In certain embodiments, the cooking surface 130 comprises a resistive heating element which is powered by electricity, with the cooking surface 130 serving as the resistive element. In other embodiments, separate heating elements may be configured beneath the cooking surface 130 which heat up and thereby cause the portions of the cooking surface 130 above the heating elements to correspondingly heat up. The cooking surface 130 may be formed from any appropriate surface known in the art for use with food preparation including, but not limited to, iron, aluminum, steel, stainless steel, porcelain, ceramic and glass.

In a preferred embodiment, the cooking unit 102 is powered by a twelve-volt battery 152 which is also connected to the vehicle main electrical charging system. The battery 152 may be configured to mount flush into the side of the tailgate body 104 as illustrated in FIG. 5 or may be located elsewhere in the vehicle. For simplicity, the exact wiring connections between the battery 152, the controls 118, and cooking surface 130 have been omitted and are not critical to the present disclosure. In certain embodiments, the cooking unit 102 may be powered by the battery of the vehicle 106. In still further embodiments, the user may select, using appropriate supplied circuitry, whether to power the cooking unit 102 with the battery 152 or the main vehicle battery. For example, an automatic switching circuit may be provided which monitors the battery 152 and alerts the user when the output of the battery 152 becomes critically low and optionally switches power to the main vehicle battery. As another example, circuitry may be provided that monitors the output of the main vehicle battery and alerts the user when the main vehicle battery becomes low. This allows the user to turn off the cooking unit 102 or run the engine (and charging system) of the vehicle 106 until sufficient battery charge is restored. While the invention has been presented in the context of a specific embodiment, this is for the purpose of illustration rather than limitation. Other variations and modifications of the specific embodiment shown and described will be apparent to those skilled in the art within the intended spirit and scope of the invention.

What is claimed:

1. An outdoor cooking device comprising:
a) a body portion;
b) a cooking unit contained in said body portion;
c) a cooking unit cover which conceals said cooking unit when said cooking unit cover is in the closed position; and
d) a storage compartment which is contained in said body portion and separate from said cooking unit;
wherein said device is hingedly to a vehicle configured to match the size and shape of a standard tailgate for the vehicle such that said the device may be installed as a direct-fit replacement for said standard tailgate;
wherein said cooking unit cover is hingedly attached to and recessed within said body portion such that the outer surface of said cooking unit cover lies flush with the outer surface of said body portion when said cooking unit cover is in the closed position.

2. The outdoor cooking device of claim 1 further comprising:
a side support for maintaining the cooking unit cover in the open position.

3. The device of claim 2, wherein the shape of said side support is substantially planar, said side support being perpendicular to said cooking unit cover when said cooking unit cover is in the open position.

4. The device of claim 3, wherein said side support comprises two straight edges, said two straight edges being adjacent and perpendicular.

5. The device of claim 3, wherein a first edge of said side support is hingedly attached to said body portion and a second edge of said side support is attachable to said cooking unit cover when said cooking unit cover and said side support are in the open position

6. The outdoor cooking device of claim 1 further comprising:
a removable grease container, said collection container comprising a generally arced shape and having a rectangular cross section, said collection container having a first opening;
a rectangular opening defined on three sides by an opening in an upper horizontal surface of said body portion and defined on a fourth side by said cooking unit; and
a curved recess within said body portion for receiving said generally arced shape of said removable grease container;
wherein said rectangular opening is sized such that said removable grease container may be inserted into said rectangular opening in a circumferential direction in relation to said generally arced shape;
wherein said first opening is positioned on a first end of said removable grease container, said first end being elevated above a second end when said device is in the closed position.

7. The device of claim 6, wherein said cooking unit further comprises:
a) a grease collection surface surrounding said cooking surface; and
b) a drain opening in said grease collection surface;
wherein said grease collection surface is curved to allow gravity to direct liquid toward said drain opening;
wherein said drain opening is configured to direct liquid to said first opening of said grease container.

8. The device of claim 1, wherein said cooking unit further comprises:
a) a continuous cooking surface for heating food, said continuous cooking surface comprising:
i) a first ridged portion containing a plurality of raised ridges; and
ii) a uniformly flat portion.

9. The device of claim 1, wherein said cooking unit cover further comprises:
a) a second ridged portion, said second ridged portion comprising a plurality of protrusions and indentions therebetween, said indentations being formed to mate reciprocally with said raised ridges of said first ridged portion when said cooking unit cover is in the closed position.

10. The device of claim 1, wherein said cooking unit contains an electrically resistive heating element and wherein said device further comprises a first battery for supplying power to said cooking unit.

11. The device of claim 10, wherein powered is supplied to said cooking unit from a second battery, said second battery located external to said device.

12. The device of claim 10, wherein said second battery is the battery connected to the electrical system of said vehicle.

13. The device of claim 1, wherein said storage compartment is insulated.

14. The device of claim 1, wherein said storage compartment further comprises a hingedly attached recessed lid.

15. The device of claim 14, further comprising a seal between said hingedly attached recessed lid and said storage compartment.

16. The device of claim 1, further comprising:
a) a latch for maintaining the device in the vertical position and releasing the device to the horizontal position; and
b) a retention strap operably connected between said vehicle and said device for maintaining the device in the horizontal position.
